(19) United States
(12) Patent Application Publication
(10) Pub. No.: US 2025/0111387 A1
(43) Pub. Date: Apr. 3, 2025

(54) TIME DISCOUNT RATE ESTIMATION APPARATUS, MACHINE LEARNING METHOD, TIME DISCOUNT RATE ANALYSIS METHOD, AND PROGRAM

(71) Applicant: NIPPON TELEGRAPH AND TELEPHONE CORPORATION, Tokyo (JP)

(72) Inventors: Shuhei YAMAMOTO, Tokyo (JP); Takeshi KURASHIMA, Tokyo (JP); Shuichi NISHIOKA, Tokyo (JP); Tomu TOMINAGA, Tokyo (JP)

(21) Appl. No.: 18/730,950

(22) PCT Filed: Feb. 24, 2022
(86) PCT No.: PCT/JP2022/007550

§ 371 Date: Jul. 22, 2024

(51) Int. Cl. G06Q 30/0201; G06N 20/00

(52) U.S. Cl. CPC G06Q 30/0201; G06N 20/00

(57) ABSTRACT

An object of the present disclosure is to accurately estimate a time discount rate of a user without depending on a measurement method using questionnaires.

Therefore, the present disclosure provides a time discount rate estimation device that estimates a time discount rate in a learning phase, the time discount rate estimation device including: a behavior transition time calculation unit that calculates a transition time from a behavior of a predetermined user recorded at each date and time to all types of behaviors of the predetermined user and outputs behavior transition time feature data for each behavior recorded at each date and time; and a time discount rate estimation model learning unit that calculates an error between a value of a time discount rate obtained by inputting the behavior transition time feature data to a time discount rate estimation model obtained by deep learning and a time discount rate serving as correct answer data based on an answer by the predetermined user and performs machine learning on the time discount rate estimation model so as to reduce the error.

### TECHNICAL FIELD

The present invention relates to a technique of analyzing a time discount rate, and particularly to a technique of accurately and automatically estimating a time discount rate of a user from a daily behavioral record of the user.

### BACKGROUND ART

Indicating human personality with quantitative numerical values is one of important elements for human understanding addressed in fields such as psychology and economics. Economics traditionally treat human personality as three types of elements: “time discount rate”, “risk aversion rate”, and “reciprocity”. Among the elements, the time discount rate is an index obtained by focusing on “how much a person hates to wait”. In particular, the time discount rate is obtained by focusing on a human nature that “a value of a certain reward is discounted based on time depending on how low a person subjectively perceives a future value of the reward (delayed reward) compared with its current value (immediate reward)” and is treated as a parameter of an attenuation function (e.g. exponential function or hyperbolic function) of the discount. The time discount rate has been statistically investigated mainly in behavioral economics in conjunction with human attributes and has been shown to be an important element affecting a wide range of life domains. For example, a high time discount rate (a person who tends to hate waiting) is correlated with high rates of debt, obesity, and smoking (Non Patent Literature 1). When the time discount rate of each individual is clarified, a person himself/herself or other people can quantitatively understand how much the person can endure “waiting” in his/her life. Based on this understanding, it is also possible to improve his/her life by supporting his/her decision making.

Methods of measuring the time discount rate by using questionnaires has been developed so far. Two measurement methods have been mainly proposed and used in various statistical surveys so far (Non Patent Literature 2). One of the methods is a measurement method using the “choice questionnaire”. For example, a plurality of questions regarding “Would you rather receive X yen today (option A) or Y yen seven days later (option B)?” is prepared such that Y yen is higher than X yen in each question, and respondents choose an option. At this time, because a price in the option B is higher, a question designer has an “annual interest” as in a bank deposit. Focusing on a question in which selection is changed from the option A (receive today) to the option B (receive seven days later) among answer results, a discount rate of a respondent is assumed to be present between an annual interest of the question in which selection is changed and an annual interest of a question before the question, and thus an average value of the two annual interests is adopted as the time discount rate. The other method is a measurement method using the “self-completed questionnaire”. This method includes, for example, a single question “If you receive X yen today or receive Y yen seven days later, please write a price Y with a value equivalent to X yen.”. and an annual interest calculated from a difference between the written price Y yen and X yen is adopted as it is as the time discount rate.

### CITATION LIST

### Non Patent Literature

Non Patent Literature 1: Mischel, Walter et al. “′Willpower′ over the life span: decomposing self-regulation.”Social cognitive and affective neuroscience, Vol. 6, No. 2 (2011): 252-6.
Non Patent Literature 2: Hardisty, David J. et al. “How to measure time preferences: An experimental comparison of three methods.” Judgment and Decision Making Vol. 8 (2013): 236-249.

### SUMMARY OF INVENTION

### Technical Problem

However, in the measurement method using the self-completed questionnaire, the burden on respondents is small because the respondents only need to answer a single question. Meanwhile, the respondents can write any price, and thus answer results of a respondent group tend to be dispersed. Therefore, it is difficult to measure an accurate time discount rate and also to compare the time discount rate with attribute information of the respondent group.

In the measurement method using the choice questionnaire, time discount rates of respondents are allocated based on annual interests determined by the question designer in advance. Thus, answers do not tend to be dispersed. Meanwhile, it is necessary to answer a plurality of questions. Further, the order of questions is randomly changed according to the annual interest in order to avoid the respondents from irresponsibly answering questions (e.g. continuing to select the option B without consideration). Thus, in a case where there is a plurality of portions where the option A and the option B are switched, many answers of the respondents are regarded as invalid. Therefore, the time discount rate cannot be appropriately measured in many cases. Further, because it is necessary to answer a plurality of questions, the burden on the respondents is heavy, and measurement is performed at medium to long time intervals. Therefore, it is difficult to detect a change thereof.

The present invention has been made in view of the above points, and an object thereof is to accurately estimate a time discount rate of an individual without depending on a measurement method using questionnaires.

### Solution to Problem

In order to achieve the above object, an invention according to claim 1 is a time discount rate estimation device (time discount rate estimation apparatus) that estimates a time discount rate in a learning phase, the time discount rate estimation device including: a behavior transition time calculation unit that calculates a transition time from a behavior of a predetermined user recorded at each date and time to all types of behaviors of the predetermined user and outputs behavior transition time feature data for each behavior recorded at each date and time; and a time discount rate estimation model learning unit that calculates an error between a value of a time discount rate obtained by inputting the behavior transition time feature data to a time discount rate estimation model obtained by deep learning and a time discount rate serving as correct answer data based on an answer by the predetermined user and performs machine learning on the time discount rate estimation model so as to reduce the error.

### Advantageous Effects of Invention

As described above, the present invention can accurately estimate a time discount rate of an individual without depending on a measurement method using questionnaires.

### BRIEF DESCRIPTION OF DRAWINGS

FIG. 1 is a functional configuration diagram of a time discount rate estimation device in a learning phase according to an embodiment.

FIG. 2 is a functional configuration diagram of a time discount rate estimation device in an estimation phase according to an embodiment.

FIG. 3 is a hardware configuration diagram of a time discount rate estimation device according to an embodiment.

FIG. 4 is a conceptual diagram of a table forming a behavior data DB.

FIG. 5 is a conceptual diagram of a table forming a time discount rate data DB.

FIG. 6 is a conceptual diagram of a table forming a time discount rate estimation model DB.

FIG. 7 is a flowchart showing an overview of time discount rate estimation processing in a learning phase.

FIG. 8 is a flowchart showing an overview of time discount rate estimation processing in an estimation phase.

FIG. 9 is a flowchart showing an overview of time discount rate estimation processing in an estimation phase.

FIG. 10 is a conceptual diagram showing an output example of a behavior data preprocessing unit.

FIG. 11 is a flowchart showing processing of a behavior transition time calculation unit.

FIG. 12 is a conceptual diagram showing an output example of a behavior transition time calculation unit.

FIG. 13 shows a network structure of a time discount rate estimation model built by a time discount rate estimation model building unit.

FIG. 14 shows a calculation image of a self-attention.

FIG. 15 is a flowchart showing processing of a time discount rate estimation model learning unit.

FIG. 16 is a flowchart showing processing of a time discount rate estimation unit.

FIG. 17 is a flowchart showing processing of an estimation result interpretation unit.

FIG. 18 shows an output example of visualization output by an estimation result interpretation unit.

### DESCRIPTION OF EMBODIMENTS

### Overview of Embodiment

In recent years, individuals have come to have wearable devices, and it has become easy to observe and digitalize daily individual behavior. Behavior is observed as a result of decision making. A correlation between a time discount rate and life behavior results such as obesity and smoking has been confirmed. Therefore, it is possible to estimate the time discount rate behind decision making by analyzing more detailed daily behavior (e.g. sleep, diet, and exercise) pattern. By estimating the time discount rate from this automatically measured behavior data, it is possible to reduce the burden of individuals answering questionnaires and to clarify the time discount rate with finer time granularity (e.g. one week or one month). This makes it possible to support self-understanding and decision making according to the lapse of time.

A time discount rate estimation device (time discount rate estimation apparatus) of the present embodiment accurately estimates the time discount rate of an individual from behavior data automatically observed by a wearable device or the like without depending on a measurement method using questionnaires.

### [Hardware Configuration of Time Discount Rate Estimation Device]

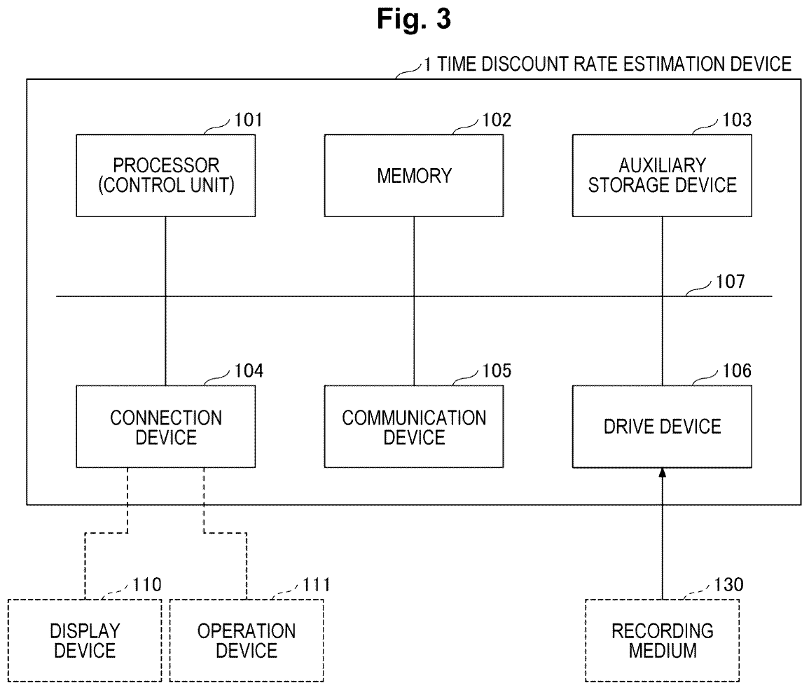

Next, a hardware configuration of a time discount rate estimation device 1 (time discount rate estimation apparatus) will be described with reference to FIG. 3. FIG. 3 is a hardware configuration diagram of the time discount rate estimation device according to the embodiment.

As shown in FIG. 3, the time discount rate estimation device 1 includes a processor 101, a memory 102, an auxiliary storage device 103, a connection device 104, a communication device 105, and a drive device 106. Pieces of hardware included in the time discount rate estimation device 1 are connected to each other via a bus 107.

The processor 101 serves as a control unit that controls the entire time discount rate estimation device 1 and includes various arithmetic devices such as a central processing unit (CPU). The processor 101 reads various programs on the memory 102 and executes the programs. The processor 101 may include a general-purpose computing on graphics processing unit (GPGPU).

The memory 102 includes a main storage device such as a read only memory (ROM) or a random access memory (RAM). The processor 101 and the memory 102 form a so-called computer, and, when the processor 101 executes the various programs read on the memory 102, the computer implements various functions.

The auxiliary storage device 103 stores the various programs and various types of information used when the various programs are executed by the processor 101.

The connection device 104 connects an external device (e.g. display device 110 or operation device 111) and the time discount rate estimation device 1.

The communication device 105 transmits and receives various types of information to and from other devices.

The drive device 106 is a device in which a (non-transitory) recording medium 130 is set. The recording medium 130 here includes a medium that optically, electrically, or magnetically records information, such as a compact disc read-only memory (CD-ROM), a flexible disk, or a magneto-optical disk. The recording medium 130 may also include a semiconductor memory or the like that electrically records information, such as a read only memory (ROM) or a flash memory.

Note that the various programs to be installed in the auxiliary storage device 103 are installed, for example, by setting the distributed recording medium 130 in the drive device 106 and reading the various programs recorded in the recording medium 130 by using the drive device 106. Alternatively, the various programs to be installed in the auxiliary storage device 103 may be installed by being downloaded from a network via the communication device 105.

### [Functional Configuration of Time Discount Rate Estimation Device]

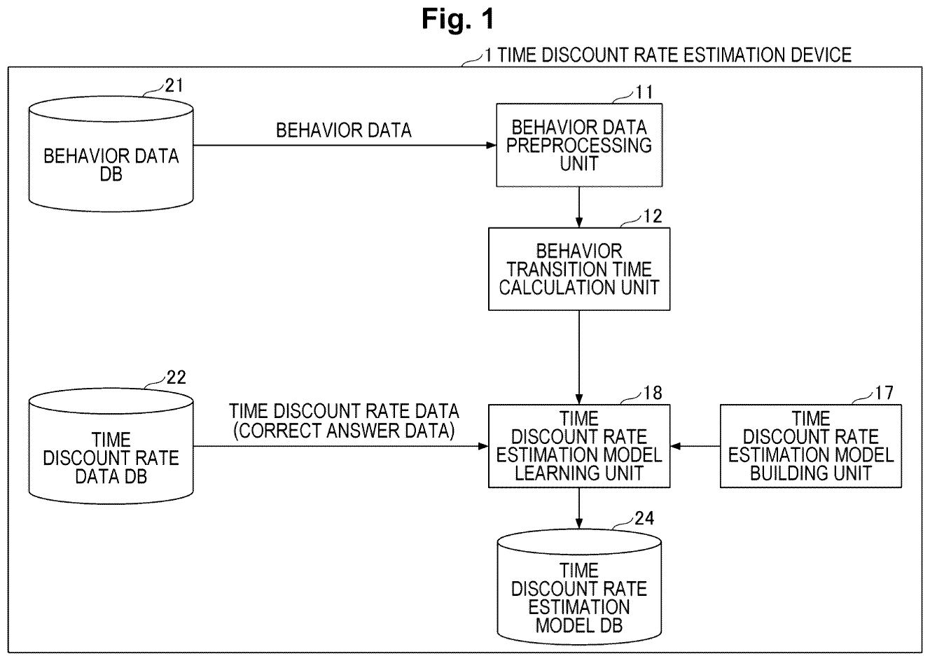

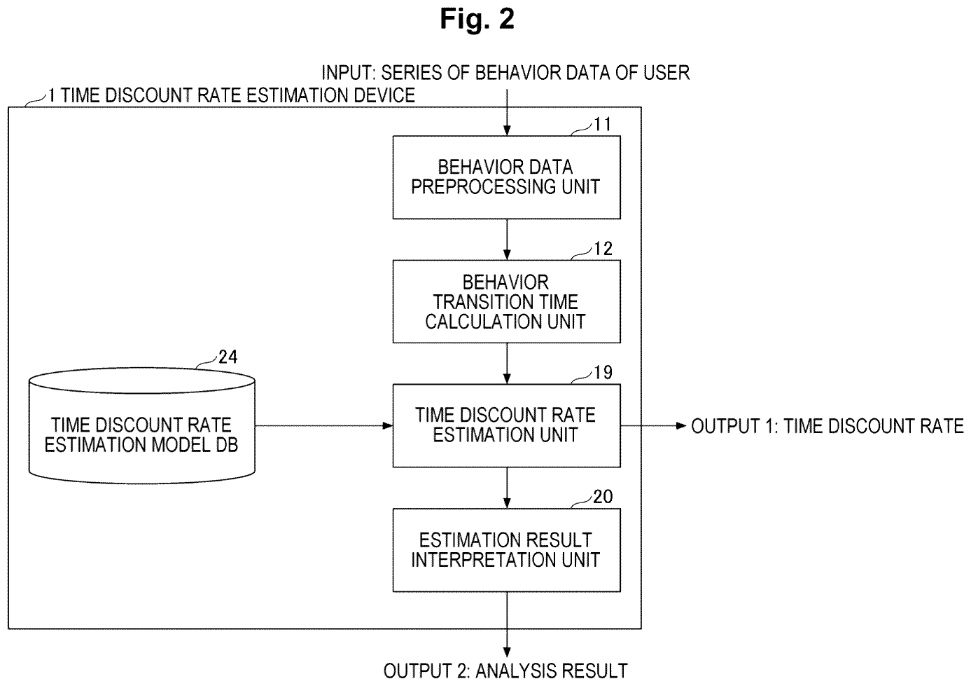

Hereinafter, one embodiment of the present invention will be described. FIG. 1 is a functional configuration diagram of the time discount rate estimation device in a learning phase according to the embodiment. FIG. 2 is a functional configuration diagram of the time discount rate estimation device in an estimation phase according to the embodiment.

As shown in FIG. 1, the time discount rate estimation device 1 in the learning phase includes a behavior data preprocessing unit 11, a behavior transition time calculation unit 12, a time discount rate estimation model building unit 17, and a time discount rate estimation model learning unit 18. Those units are functions implemented by commands from the processor 101 of FIG. 3 based on a program.

The time discount rate estimation device 1 in the learning phase further includes a behavior data database (DB) 21, a time discount rate data DB 22, and a time discount rate estimation model DB 24. Each of the DBs is built in the memory 102 or an auxiliary storage device 203 described later. The time discount rate estimation device 1 in the learning phase outputs a learned time discount rate estimation model by using information in each DB. Hereinafter, the time discount rate model may be simply referred to as a “model”.

Meanwhile, as shown in FIG. 2, the time discount rate estimation device 1 in the estimation phase includes the behavior data preprocessing unit 11, the behavior transition time calculation unit 12, a time discount rate estimation unit 19, and an estimation result interpretation unit 20. Those units are functions implemented by commands from the processor 101 of FIG. 3 described later based on a program.

The time discount rate estimation device 1 in the estimation phase further includes the time discount rate estimation model DB 24. The time discount rate estimation model DB is built in the memory 102 or the auxiliary storage device 203. The time discount rate estimation device 1 in the learning phase outputs a learned time discount rate estimation model by using information in each DB.

### <Behavior Data DB>

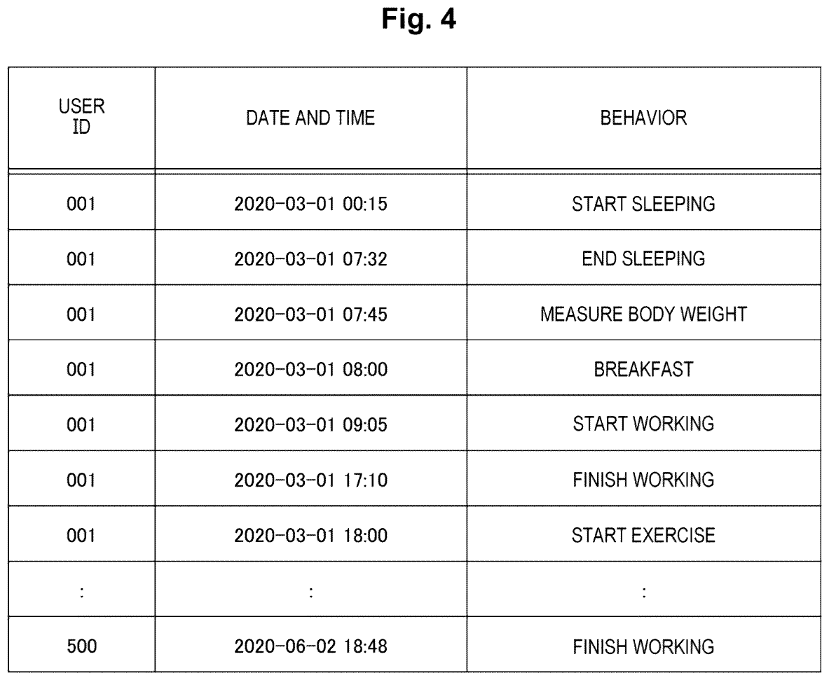

FIG. 4 is a conceptual diagram of a table forming the behavior data DB. The behavior data BD 21 stores a behavior automatically recorded by a wearable device or recorded by a user himself/herself in association with a user ID together with date and time of the behavior of the user specified by the user ID and a character string indicating the type (content) of the behavior. The type of behavior may be stored in the behavior data DB 21 within a range in which a system administrator can collect the type of behavior. The user ID is an example of user identification information, and a symbol or numerical value that can uniquely specify the user may be allocated. Specifically, the table is configured as follows.

### <Time Discount Rate Data DB>

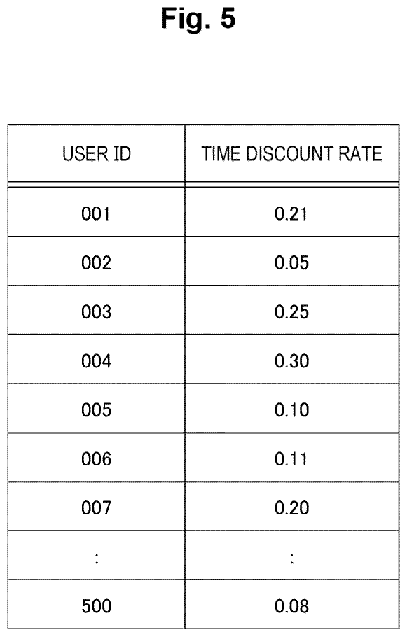

FIG. 5 is a conceptual diagram of a table forming the time discount rate data DB. In the time discount rate data DB 22, the time discount rate is managed for each user ID.

### <Time Discount Rate Estimation Model DB>

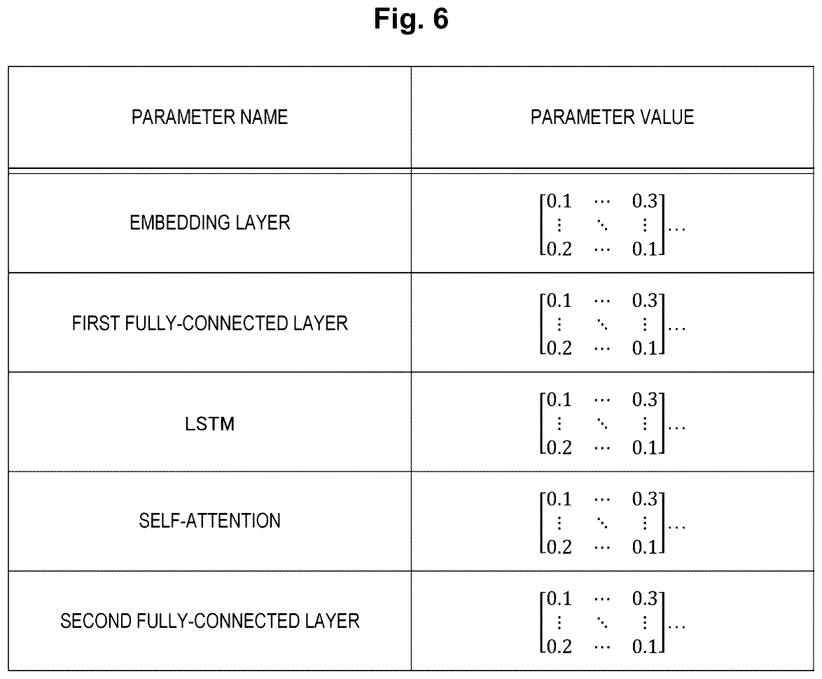

FIG. 6 is a conceptual diagram of a table forming the time discount rate estimation model DB. The time discount rate estimation model DB 24 manages, for each model parameter name for machine learning, parameter values regarding the parameter name.

### <Each Functional Configuration>

Next, each functional configuration of the time discount rate estimation device 1 in the learning phase will be described.

The behavior data preprocessing unit 11 performs preprocessing of behavior data by deleting, from the behavior data, data regarding behaviors of the same type successively observed in a predetermined time, then giving a unique behavior ID associated with the type of behavior, and associating the behavior ID with behavior transition time feature data.

The behavior transition time calculation unit 12 calculates a transition time from a behavior of a predetermined user recorded at each date and time to all types of behaviors of the predetermined user and outputs behavior transition time feature data for each behavior recorded at each date and time.

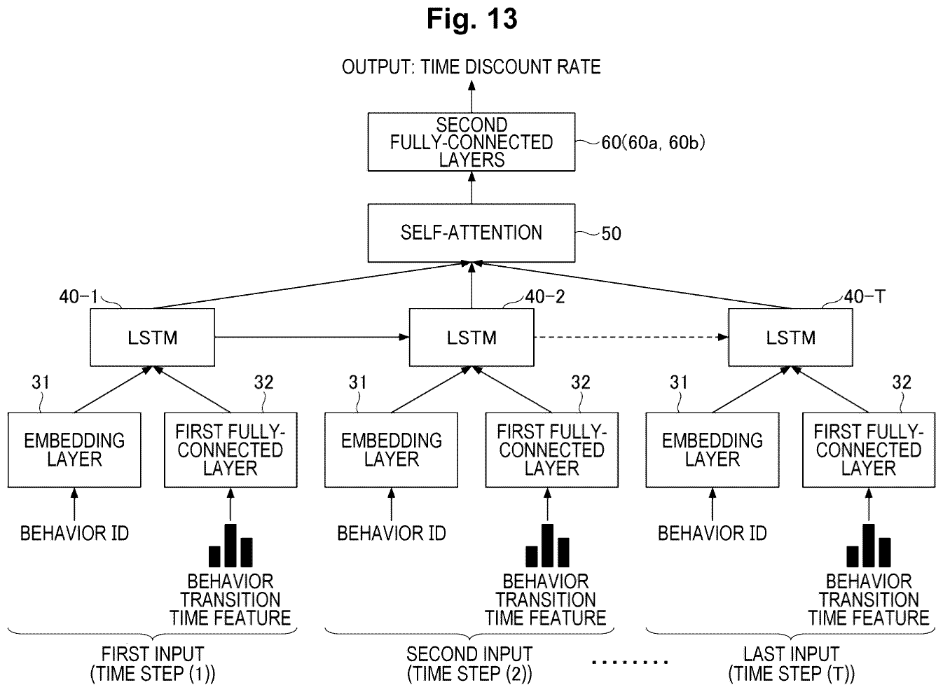

The time discount rate estimation model building unit 17 builds a structure of a time discount rate estimation model shown in FIG. 13 described later.

The time discount rate estimation model learning unit 18 calculates an error between a value of a time discount rate, which is obtained by inputting the behavior transition time feature data to a time discount rate estimation model obtained by a deep neural network (DNN) (deep learning), and a time discount rate serving as correct answer data based on an answer by the predetermined user and performs machine learning on the time discount rate estimation model so as to reduce the error.

By using machine-learned model parameters (time discount rate estimation model), the time discount rate estimation unit 19 calculates a time discount rate based on behavior data (input data) indicating a behavior of a specific user recorded at each date and time and outputs the time discount rate.

The estimation result interpretation unit 20 visualizes importance of the behavior of the specific user recorded at each date and time based on a weight (importance) for each transition time and outputs the importance.

Each of the above units will be described in detail later.

### Processing or Operation of Embodiment

Next, an overview of processing or operation of the present embodiment will be described, and then detailed processing will be described. The processing will be described separately in the learning phase and the estimation phase.

### <Overview of Processing>

### (Overview of Processing in Learning Phase)

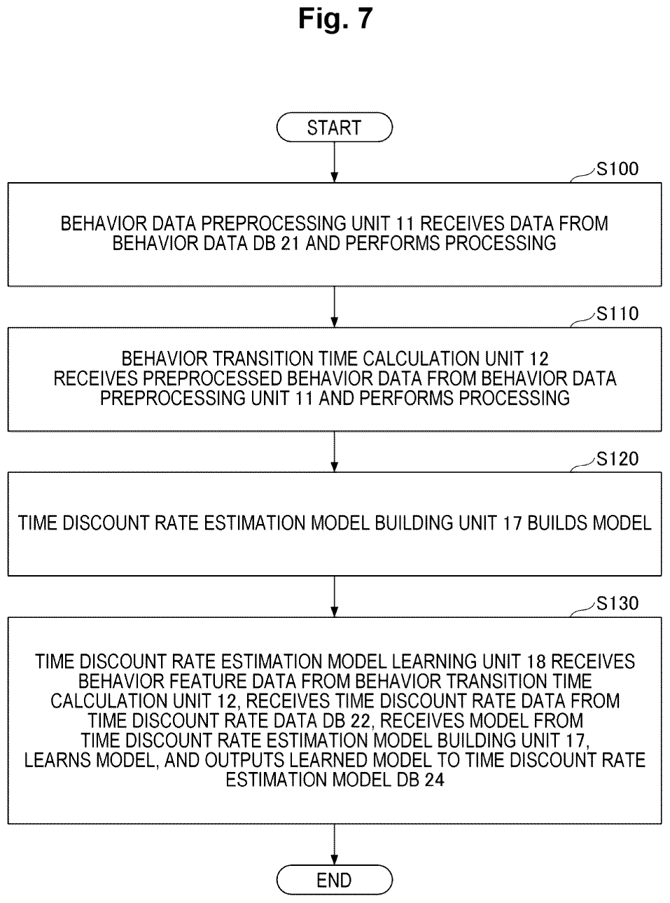

FIG. 7 is a flowchart showing an overview of time discount rate estimation processing in the learning phase.

First, the behavior data preprocessing unit 11 receives behavior data of each person (see FIG. 4) from the behavior data DB 21 and performs processing (S100). The processing will be described later in detail.

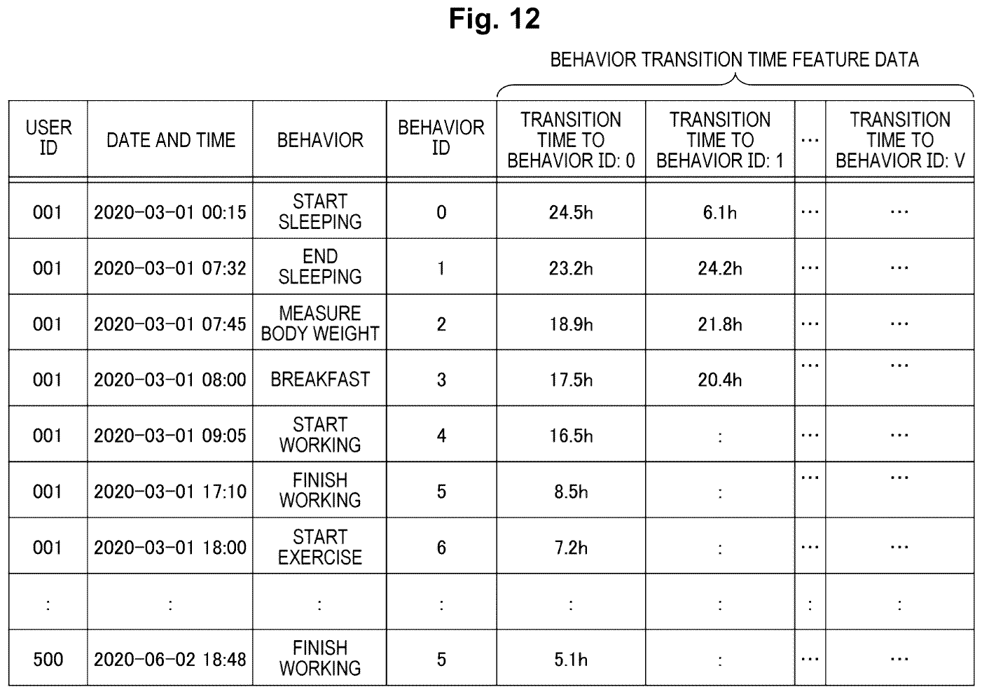

The behavior transition time calculation unit 12 receives the preprocessed behavior data from the behavior data preprocessing unit 11 and performs processing (S110). The processing will be described later in detail. FIG. 12 shows an example of data obtained as output of the behavior transition time calculation unit 12. As shown in FIG. 12, output data of the behavior transition time calculation unit 12 is associated with the user ID, date and time of occurrence of a behavior, content (type) of the behavior, the behavior ID, and the behavior transition time feature data. Each transition time indicates a time of difference between date and time of start of a behavior and date and time of start of another behavior. Here, as can be seen from the fact that a plurality of user IDs “001” is managed, a plurality of behavior transition times of one user is shown.

The time discount rate estimation model building unit 17 builds a time discount rate estimation model (S120). The processing will be described later in detail.

The time discount rate estimation model learning unit 18 receives the behavior transition time feature data from the behavior transition time calculation unit 12, receives time discount rate data as correct answer data of machine learning from the time discount rate data DB 22, receives the time discount rate estimation model from the time discount rate estimation model building unit 17, learns the model, and outputs the learned model to the time discount rate estimation model DB 24.

### (Overview of Processing in Estimation Phase)

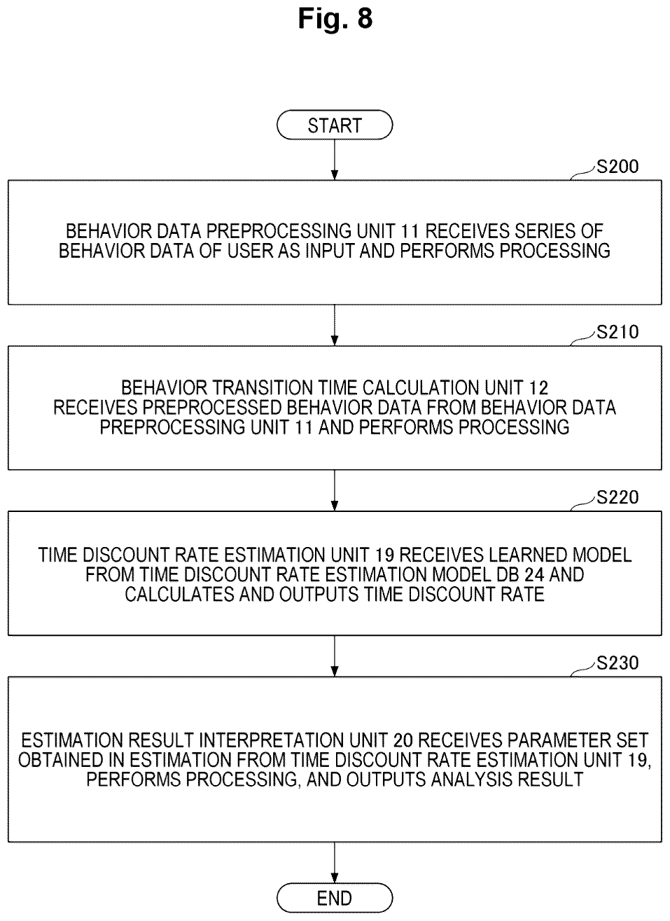

FIG. 8 is a flowchart showing an overview of the time discount rate estimation processing in the estimation phase.

First, the behavior data preprocessing unit 11 receives a series of behavior data of a user as an input and performs processing (S200).

The behavior transition time calculation unit 12 receives the preprocessed behavior data from the behavior data preprocessing unit 11 and performs processing (S210).

The time discount rate estimation unit 19 receives the learned model from the time discount rate estimation model DB 24 and calculates and outputs a time discount rate (S220). The processing will be described later in detail.

The estimation result interpretation unit 20 receives a parameter set obtained in the estimation from the time discount rate estimation unit 19, performs processing, and outputs an analysis result (S230). The processing will be described later in detail.

### <Detailed Processing>

Next, detailed processing of the learning phase will be described.

### (Detailed Processing of Behavior Data Preprocessing Unit)

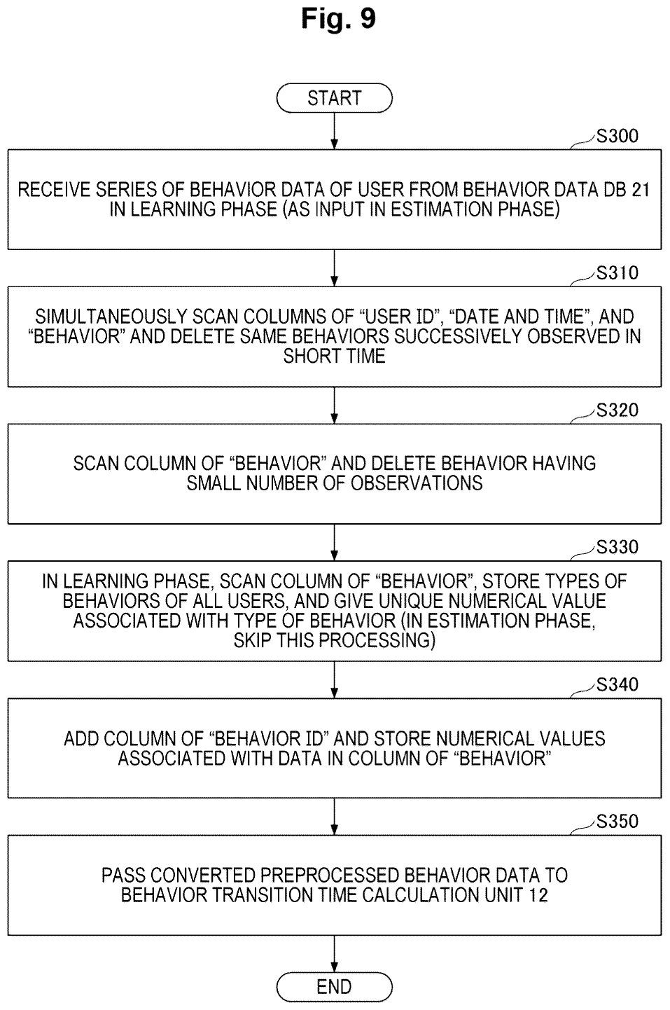

Detailed processing of the behavior data preprocessing unit 11 will be described with reference to FIG. 9. FIG. 9 is a flowchart showing the processing of the behavior data preprocessing unit.

First, the behavior data preprocessing unit 11 receives a series of behavior data shown in FIG. 4 as an example of the behavior data of the user from the behavior data DB 21 in the learning phase and as an input in the estimation phase (S300).

The behavior data preprocessing unit 11 simultaneously scans columns of “user ID”, “date and time”, and “behavior” in FIG. 4 and deletes data regarding behaviors of the same type successively observed in a predetermined short time (e.g. 10 minutes). For example, in a case where a behavior “start exercise” of a certain user is successively observed many times in a short time, the behavior data preprocessing unit 11 leaves only the first observed behavior “start exercise” and deletes the other same behaviors as erroneously observed behaviors. A time span may be set by the system administrator.

The behavior data preprocessing unit 11 scans the column of “behavior” in FIG. 4 and deletes a behavior having a small number of observations. Specifically, the behavior data preprocessing unit 11 counts the number of appearances for each type of behavior and deletes a behavior falling below the number of appearances defined by the system administrator. A threshold of the number of appearances may be set by the system administrator.

In the learning phase, the behavior data preprocessing unit 11 scans the column of “behavior” in FIG. 4, stores types of behaviors of all users, and gives a behavior ID indicating a unique numerical value associated with the type of behavior (S330). In the estimation phase, the processing (S330) is omitted.

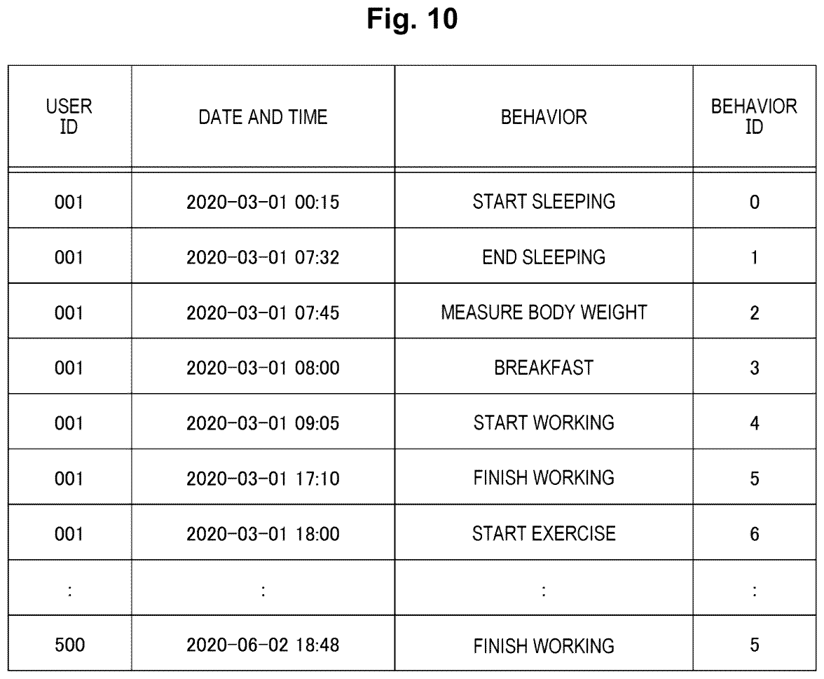

The behavior data preprocessing unit 11 adds a column of “behavior ID” and stores the numerical values associated with the data in the column of “behavior” (see FIG. 10) (S340).

The behavior data preprocessing unit 11 passes the preprocessed behavior data (see FIG. 10) converted by the processing (S340) to the behavior transition time calculation unit 12 (S350).

### (Detailed Processing of Behavior Transition Time Calculation Unit)

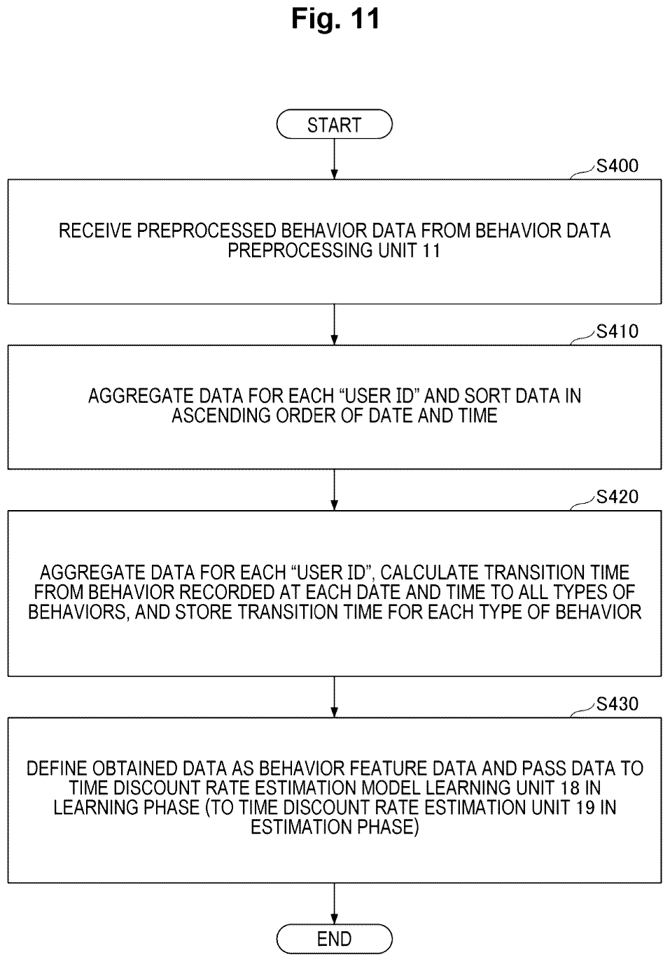

Detailed processing of the behavior transition time calculation unit 12 will be described with reference to FIG. 11. FIG. 11 is a flowchart showing the processing of the behavior transition time calculation unit.

First, the behavior transition time calculation unit 12 receives the converted preprocessed behavior data from the behavior data preprocessing unit 11 (S400).

The behavior transition time calculation unit 12 aggregates data for each “user ID” in FIG. 10 and calculates an average value for each behavior amount (for each column) (S410).

The behavior transition time calculation unit 12 aggregates data for each “user ID”, calculates a transition time from a behavior recorded at each date and time to all types of behaviors, and stores the transition time in the memory 102 for each type of behavior (S420). Specifically, when a behavior at certain date and time is targeted, the behavior transition time calculation unit 12 scans data on and after the date and time, extracts date and time at which each of all the types of behaviors is observed for the first time, and calculates a difference therebetween. The behavior transition time calculation unit 12 stores, in the memory 102, a value indicating missing such as NULL for a behavior that is not observed after the date and time.

The behavior transition time calculation unit 12 defines the data obtained in the processing (S420) as behavior transition time feature data (see FIG. 12), passes the data to the time discount rate estimation model learning unit 18 in the learning phase, and passes the data to the time discount rate estimation unit 19 in the estimation phase (S430).

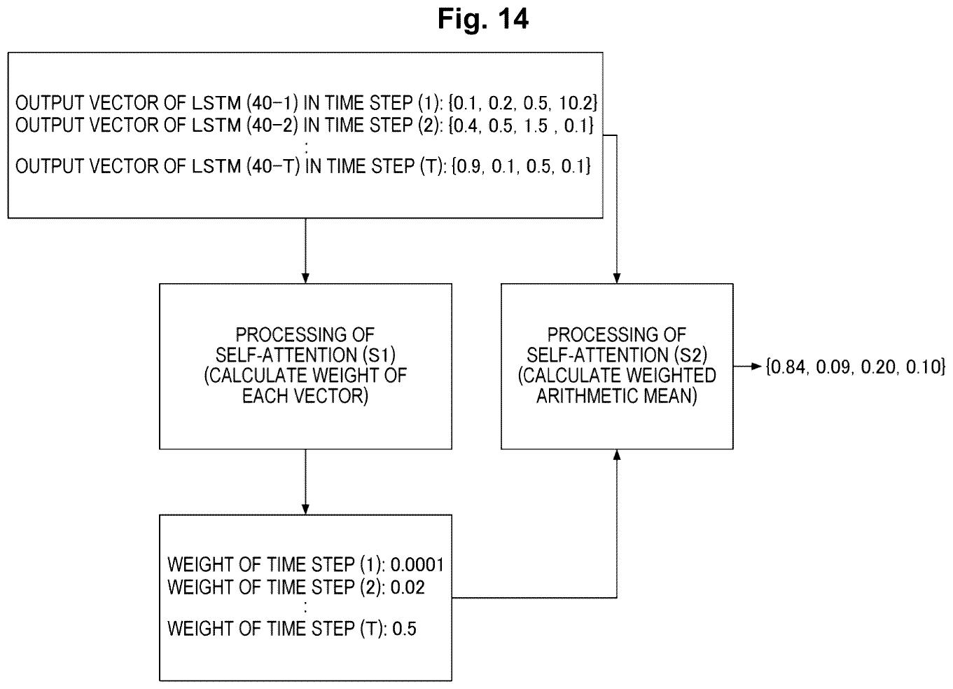

Next, an example of the time discount rate estimation model built by the time discount rate estimation model building unit 17 will be described with reference to FIGS. 13 and 14. The time discount rate estimation model is built by a DNN structure. FIG. 13 shows an example of the time discount rate estimation model built by the time discount rate estimation model building unit. FIG. 14 shows a calculation image of a self-attention 50.

The time discount rate estimation model receives behavior transition time feature data of a predetermined user as input data and generates time discount rate data of the same predetermined user as output data. A network structure of the time discount rate estimation model by the DNN includes the following units.

The first unit is an embedding layer 31 that extracts an abstract feature from the behavior ID. The embedding layer 31 converts the behavior ID in FIG. 12 into one-hot representation having the number of dimensions corresponding to the number of types of behaviors and converts the one-hot representation into a feature vector having dimensions defined by the system administrator.

The second unit is a first fully-connected layer 32 that extracts an abstract feature from the behavior transition time feature data in FIG. 12. The first fully-connected layer 32 uses, for example, a sigmoid function or a ReLu function to perform nonlinear transformation on a feature value of the input data, thereby obtaining a feature vector. In the first input in FIG. 13, the “behavior ID” and the “behavior transition time feature data” in the uppermost record in FIG. 12 are input. In the second input in FIG. 13, the “behavior ID” and the “behavior transition time feature data” in the second record from the top in FIG. 12 are input. In this way, input is continued to the last record for the same user ID.

The third unit is a long-short term memory (LSTM) that further abstracts an abstracted 64-dimensional feature vector as sequential data. Specifically, a plurality of LSTMs 40-1, 40-2, . . . , 40-T sequentially receives sequential data for each time step and repeatedly performs nonlinear transformation while considering the past abstracted information. Note that an arbitrary LSTM of the plurality of LSTMs 40-1, 40-2, . . . , and 40-T will be referred to as an LSTM 40.

The fourth unit is the self-attention 50 that calculates a weighted arithmetic mean in order to obtain a feature vector in consideration of importance of a set of the feature vectors abstracted by the LSTMs 40. Weighting calculation is implemented by two fully-connected layers. A first layer 60a of second fully-connected layers receives each feature vector abstracted by the LSTM as an input and outputs a context vector of an arbitrary size. A second layer 60b of the second fully-connected layers receives the context vector as an input and outputs a scalar value corresponding to the importance. The context vector may be subjected to nonlinear transformation. The importance is converted into a value corresponding to a probability value by, for example, a softmax function.

The fifth unit is the second fully-connected layers 60 that convert the weighted arithmetic mean feature vector by the self-attention 50 to a scalar value corresponding to the time discount rate.

Here, the calculation image of the self-attention 50 will be described with reference to FIG. 14. In FIG. 14, a 64-dimensional output vector is simplified and shown as a 4-dimensional output vector. A size of the output vector of each LSTM can be arbitrarily adjusted.

As shown in FIG. 14, the self-attention 50 calculates a weight of each time step based on the output vectors of the LSTMs 40 in time steps (1), (2), . . . , and (T) (S1). Here, the weight of the time step (1) is “0.0001”. Each of the weights is also used by the estimation result interpretation unit 20.

Next, the self-attention 50 calculates a weighted arithmetic mean (S2). For example, the weight 0.0001× the output vectors {0.1, 0.2, 0.5, 10.2}={0.00001, 0.00002, 0.00005, 0.00102} are satisfied in the time step (1), and the weight 0.02× the output vectors (0.4, 0.5, 1.5, 0.1}= (0.008, 0.01, 0.03, 0.00} are satisfied in the time step (2). This calculation is performed up to the time step (T). Then, the self-attention 50 adds vector values for each dimension to obtain output data having the same number of dimensions as the output vectors of the LSTMs 40. For example, in a case where all values in the first dimension are added, the added value is 0.4+0.008+ . . . =0.84 as shown in FIG. 14. Similarly, in a case where all values in the second dimension are added, the added value is 0.09, in a case where all values in the third dimension are added, the added value is 0.20, and, in a case where all values in the fourth dimension are added, the added value is 0.10. In this manner, as shown in FIG. 12, the behavior transition time feature data based on the 64-dimensional feature vector includes the behavior ID indicating a behavior such as start of sleep and the behavior transition time feature data that is a transition time to each of other behaviors.

### (Detailed Processing of Time Discount Rate Estimation Model Learning Unit)

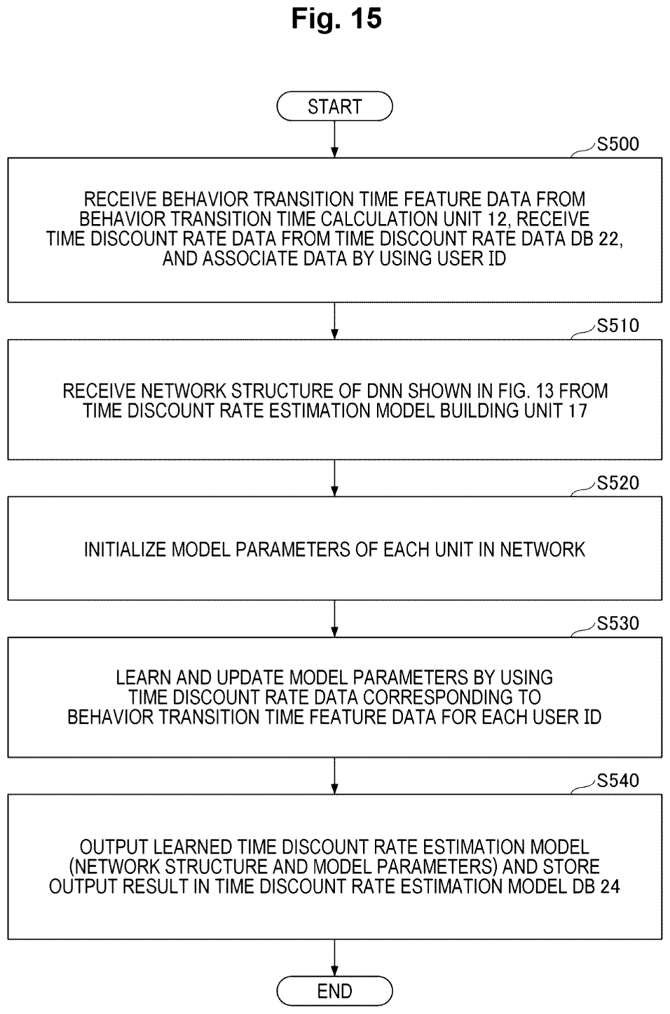

Detailed processing of the time discount rate estimation model learning unit 18 will be described with reference to FIG. 15. FIG. 15 is a flowchart showing the processing of the time discount rate estimation model learning unit.

As shown in FIG. 15, the time discount rate estimation model learning unit 18 receives the behavior transition time feature data from the behavior transition time calculation unit 12, receives the time discount rate data as correct answer data from the time discount rate data DB 22, and associates the data by using the user ID (S500).

The time discount rate estimation model learning unit 18 receives the network structure (framework) of the DNN shown in FIG. 13 from the time discount rate estimation model building unit 17 (S510).

The time discount rate estimation model learning unit 18 initializes model parameters of each unit in the network structure (S520). For example, the time discount rate estimation model learning unit 18 initializes the model parameters with random numbers from 0 to 1.

The time discount rate estimation model learning unit 18 learns and updates the time discount rate. estimation model (model parameters) by using the time discount rate data corresponding to the behavior transition time feature data for each user ID (S530). In learning the parameters, machine learning is performed on the time discount rate estimation model (model parameters) by using a known technique such as backpropagation so as to reduce an error between a value of the time discount rate output by the second fully-connected layers 60 and the time discount rate data serving as the correct answer data.

The time discount rate estimation model learning unit 18 outputs the learned time discount rate estimation model (the network structure (see FIG. 13) and the model parameters (see FIG. 6)) and stores the output result in the time discount rate estimation model DB 24.

### (Detailed Processing of Time Discount Rate Estimation Unit)

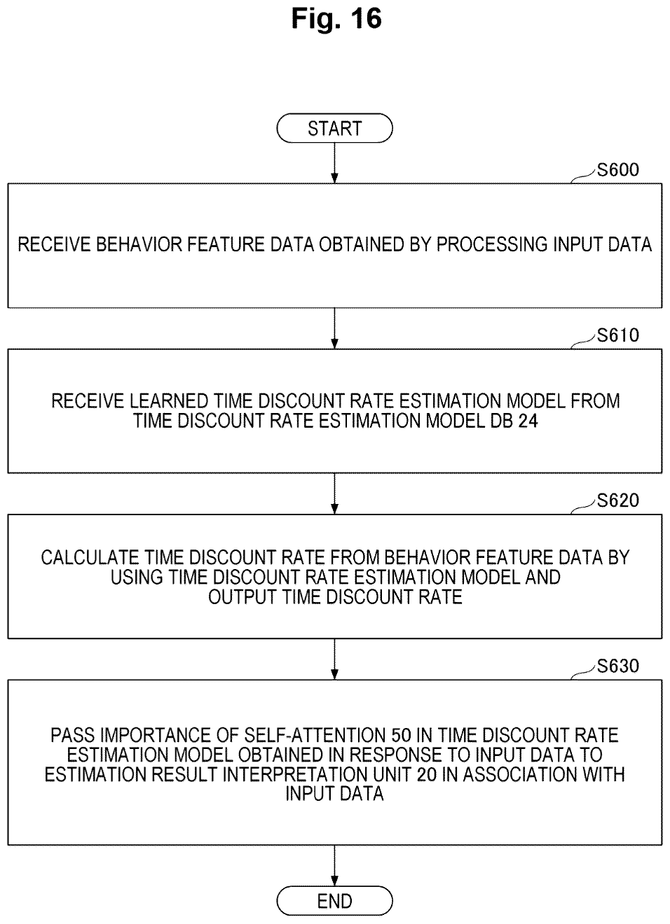

Detailed processing of the time discount rate estimation unit 19 will be described with reference to FIG. 16. FIG. 16 is a flowchart showing the processing of the time discount rate estimation unit.

First, the time discount rate estimation unit 19 receives, from the behavior transition time calculation unit 12, the behavior transition time feature data obtained when the behavior transition time calculation unit 12 processes input data (S600).

The time discount rate estimation unit 19 receives the learned time discount rate estimation model from the time discount rate estimation model DB 24 (S610).

The time discount rate estimation unit 19 calculates a time discount rate from the behavior transition time feature data by using the learned time discount rate estimation model and outputs the time discount rate (S620).

The time discount rate estimation unit 19 passes importance of the self-attention in the learned time discount rate estimation model obtained in response to the input data to the estimation result interpretation unit 20 in association with the input data (S630).

### (Detailed Processing of Estimation Result Interpretation Unit)

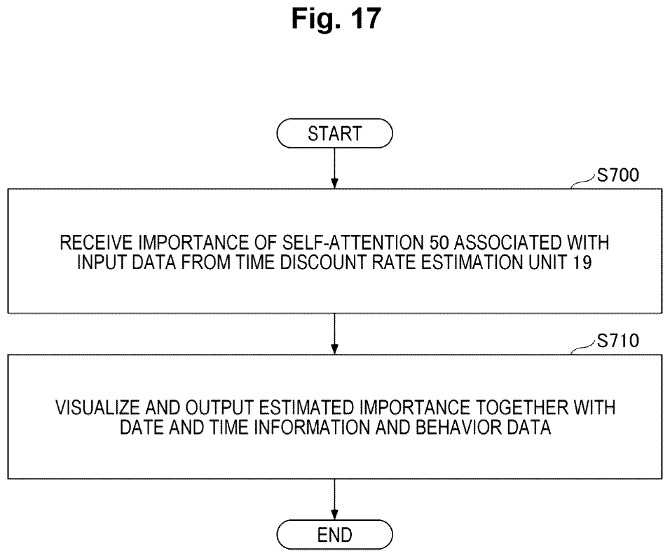

Detailed processing of the estimation result interpretation unit 20 will be described with reference to FIG. 17. FIG. 17 is a flowchart showing the processing of the estimation result interpretation unit.

First, the estimation result interpretation unit 20 receives the importance (“weight” in FIG. 14) of the self-attention associated with the input data from the time discount rate estimation unit 19 (S700).

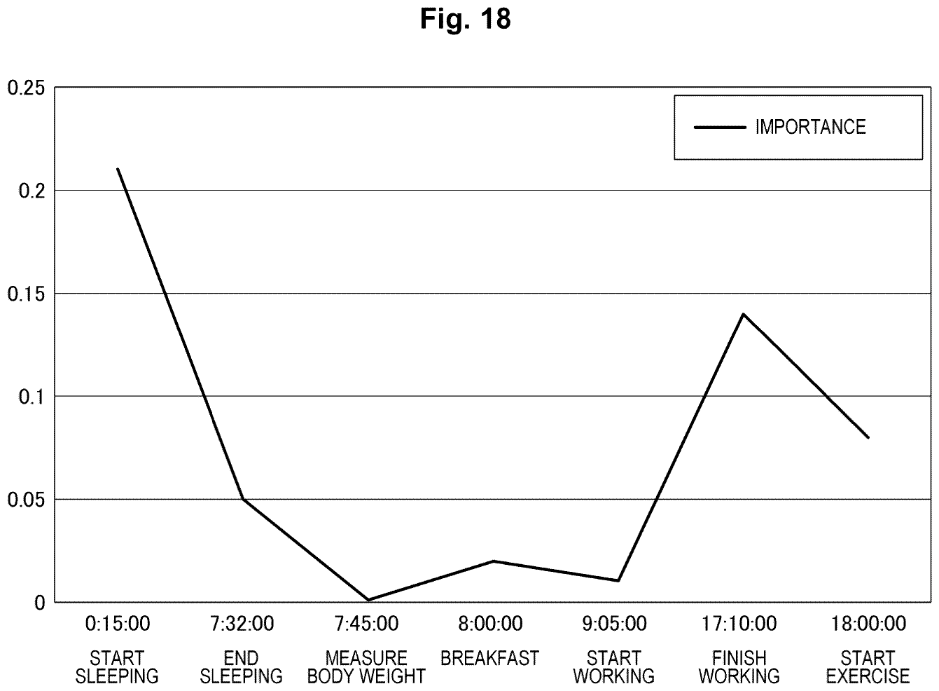

The estimation result interpretation unit 20 visualizes and outputs the estimated importance together with date and time information and each behavior (S710). FIG. 18 shows an output example of the visualization output by the estimation result interpretation unit 20. In FIG. 18, a horizontal axis represents the date and time information and behavior (type) at that time, and a vertical axis represents values of the importance. The values of the importance are visualized as a line graph with respect to the date and time information. That is, the graph of FIG. 18 visualizes how much a behavior at which date and time contributes to the time discount rate. The reason why the visualization can be made as described above is that, although the complicated network structure in FIG. 13 is used, time steps (behaviors at respective dates and times) are not collected for each user, but are input to the time discount rate estimation model as they are in FIGS. 13 and 14. For example, a user having a high time discount rate tends to think negatively about things. However, it can be seen from in FIG. 18 that importance (contribution) of start of sleep is high, and thus the user can try to reduce the time discount rate by making a sleep start time earlier or later. Therefore, in a case where only the time discount rate output by the time discount rate estimation unit 19 is used, the user can only grasp whether the user tends to think positively or negatively. Meanwhile, based on the analysis result output by the estimation result interpretation unit 20, the user can grasp that the user may be able to think positively about things by changing some behavior in his/her lifestyle.

### Main Effects of Embodiment

As described above, according to the present embodiment, the time discount rate estimation device 1 can estimate the time discount rate from behavior observed by a wearable device or the like, and thus it is possible to accurately estimate the time discount rate of an individual without depending on a measurement method using questionnaires.

The behavior data preprocessing unit 11 processes conversion, aggregation, and the like of behavior data, and thus the behavior transition time calculation unit 12 can easily handle the behavior data.

The time discount rate estimation model learning unit 18 processes the behavior data as sequential data by using the time discount rate estimation model of the DNN shown in FIG. 13, and thus the time discount rate estimation unit 19 can extract a feature in consideration of the context of behavior and can accurately estimate the time discount rate of the user.

The behavior transition time calculation unit 12 calculates a transition time between behaviors in the behavior data and uses the transition time as an input feature, and thus the time discount rate estimation unit 19 can consider a transition relationship between the behaviors and can accurately estimate the time discount rate of the user.

The time discount rate estimation unit 19 outputs, as an analysis result, which behavior at which date and time strongly affects the time discount rate estimated from a series of behavior data, thereby providing interpretability of the estimation result.

### [Supplementary Notes]

The present invention is not limited to the above embodiments and may be configured or processed (operated) as described below.

Each functional configuration of the time discount rate estimation device 1 can be implemented by a computer and a program as described above, but the program can also be recorded in a (non-transitory) recording medium or provided through a network such as the Internet.

### REFERENCE SIGNS LIST

1 Time discount rate estimation device
11 Behavior data preprocessing unit
12 Behavior transition time calculation unit
17 Time discount rate estimation model building unit
18 Time discount rate estimation model learning unit
19 Time discount rate estimation unit
20 Estimation result interpretation unit
21 Behavior data DB
22 Time discount rate data DB
24 Time discount rate estimation model DB

1. A time discount rate estimation apparatus that estimates a time discount rate in a learning phase, the time discount rate estimation apparatus comprising:
a processor; and
a memory that includes instructions, which when executed, cause the processor to execute:
calculating a transition time from a behavior of a predetermined user recorded at each date and time to all types of behaviors of the predetermined user and outputs behavior transition time feature data for each behavior recorded at each date and time; and
calculating an error between a value of a time discount rate obtained by inputting the behavior transition time feature data to a time discount rate estimation model obtained by deep learning and a time discount rate serving as correct answer data based on an answer by the predetermined user and performing machine learning on the time discount rate estimation model so as to reduce the error.

2. The time discount rate estimation apparatus according to claim 1, wherein
the plurality of behavior features of the predetermined user is based on behavior data observed by a wearable device worn by the predetermined user.

3. The time discount rate estimation apparatus according to claim 1, further comprising
performing preprocessing of behavior data indicating the behavior of the predetermined user by deleting, from the behavior data, data regarding behaviors of the same type successively observed in a predetermined time, then giving unique behavior identification information associated with the type of behavior, and associating the behavior identification information with the behavior transition time feature data.

4. A time discount rate estimation apparatus that estimates a time discount rate in an estimation phase, the time discount rate estimation apparatus comprising:
a processor; and
a memory that includes instructions, which when executed, cause the processor to execute:
calculating a time discount rate based on behavior data indicating a behavior of a specific user recorded at each date and time and outputting the time discount rate by using a machine-learned time discount rate estimation model obtained by calculating an error between a value of a time discount rate obtained by inputting behavior transition time feature data indicating a transition time from a behavior of a predetermined user recorded at each date and time to all types of behaviors of the predetermined user to a time discount rate estimation model obtained by deep learning and a time discount rate serving as correct answer data based on an answer by the predetermined user and performing machine learning so as to reduce the error.

5. The time discount rate estimation apparatus according to claim 4, wherein:
the time discount rate estimation model includes a self-attention that calculates a weight for each transition time; and
the instructions, which when executed, further cause the processor to execute:
visualizing importance of the behavior of the specific user recorded at each date and time based on the weight for each transition time and outputting the importance.

6. A machine learning method of performing machine learning on a time discount rate estimation model for estimating a time discount rate in a learning phase, the machine learning method comprising:
calculating a transition time from a behavior of a predetermined user recorded at each date and time to all types of behaviors of the predetermined user and outputting behavior transition time feature data for each behavior recorded at each date and time, and
calculating an error between a value of a time discount rate obtained by inputting the behavior transition time feature data to a time discount rate estimation model obtained by deep learning and a time discount rate serving as correct answer data based on an answer by the predetermined user and performing machine learning on the time discount rate estimation model so as to reduce the error.

7. A time discount rate estimation method of estimating a time discount rate in an estimation phase, the time discount rate estimation method comprising:
calculating a time discount rate based on behavior data indicating a behavior of a specific user recorded at each date and time and outputting the time discount rate, by using a machine-learned time discount rate estimation model obtained by calculating an error between a value of a time discount rate obtained by inputting behavior transition time feature data indicating a transition time from a behavior of a predetermined user recorded at each date and time to all types of behaviors of the predetermined user to a time discount rate estimation model obtained by deep learning and a time discount rate serving as correct answer data based on an answer by the predetermined user and performing machine learning so as to reduce the error.

8. A non-transitory computer-readable recording medium having computer-readable instructions stored thereon, which when executed, cause a computer to execute the method according to claim 6.
